(19) United States
(12) Patent Application Publication
(10) Pub. No.: US 2006/0047758 A1
(43) Pub. Date: Mar. 2, 2006

(54) Extending and optimizing electronic messaging rules

(76) Inventors: Vivek Sharma, Redmond, WA (US); Min Wei, Bellevue, WA (US); Robert George Atkinson, Woodinville, WA (US)

Correspondence Address: RICK D. NYDEGGER;WORKMAN NYDEGGER, 1000 Eagle Gate Tower, 60 East South Temple, Salt Lake City, UT, 84111, US

(21) Appl. No.: 10/926,929

(22) Filed: Aug. 26, 2004

(51) Int. Cl. G06F 15/16

(52) U.S. Cl. 709/206

(57) ABSTRACT

The present invention extends to methods, systems, and computer program products for extending and optimizing electronic messaging rules. A messaging module automatically generates intermediate language instructions that represent messaging rules. The intermediate language instructions are decompiled into corresponding source code and modified to extend the functionality of the messaging rules. The modified source code is recompiled into modified intermediate language instructions that are executable by a rule execution module. A criteria evaluator identifies portions of intermediate language rule instructions that can be can be rewritten to facilitate more efficient rule execution. An intermediate language rewriter optimizes the identified portions of intermediate language rule instructions based on rule optimization data. For example, a series of otherwise linearly executed conditional statements can be rewritten as a balanced binary tree or character by character comparison string matching can be rewritten as a single hash comparison.

### CROSS-REFERENCE TO RELATED APPLICATIONS

Not applicable.

### BACKGROUND OF THE INVENTION

1. The Field of the Invention

The present invention relates to messaging rules and, more particularly, to extending and optimizing electronic messaging rules.

2. Background and Relevant Art

Computer systems and related technology affect many aspects of society. Indeed, the computer system's ability to process information has transformed the way we live and work. Computer systems now commonly perform a host of tasks (e.g., word processing, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, many tasks performed at a computer system (e.g., voice communication, accessing electronic mail, controlling home electronics, Web browsing, and printing documents) include the exchange of electronic messages between a number of computer systems and/or other electronic devices via wired and/or wireless computer networks.

Networks have in fact become so prolific that a simple network-enabled computing system may communicate with any one of millions of other computing systems spread throughout the globe over a conglomeration of networks often referred to as the “Internet”. Such computing systems may include desktop, laptop, or tablet personal computers; Personal Digital Assistants (PDAs); telephones; or any other computer or device capable of communicating over a digital network.

In particular, due at least in part to the ease and insignificant cost of exchanging electronic mail messages, many computer system users rely heavily on electronic mail as a mechanism for business and personal communications. The increased reliance on electronic messaging has resulted in a great increase in the number of electronic messages a user sends and receives daily. Some electronic mails messages, for example, from family members or business associates, are often wanted and even solicited by the user. On the other hand, many electronic mail messages are unwanted and/or unsolicited electronic mail messages (commonly referred to as “SPAM”). For example, similar to postal mail advertising and telephone solicitations, electronic message recipients are increasingly being subject to unsolicited mass mailings.

Due to the number and type of electronic mail messages a user can receive, many electronic mail applications include at least some ability to automatically manipulate electronic mail messages based on electronic mail rules. Electronic mail rules allow users to efficiently organize electronic mail messages and perform message related operations without spending a lot of time manually sorting through their inbox, deleting, filing, forwarding, and responding to their electronic mail messages. For example, electronic mail rules facilitate the ability to delete SPAM or otherwise store SPAM in a separate folder.

Further, many electronic mail applications include a rules interface that allows users to create custom electronic mail rules. Custom electronic mail rules can be configured to perform a specified rule action when an electronic mail message satisfies corresponding specified rule criteria. For example, a user can set up a mail rule to automatically move a received electronic mail messages to a particular folder based on the sender of the electronic mail message. Thus, an electronic mail message from a family member (determined based on “From” field containing an e-mail address of a family member) can be automatically moved to a “Family” folder.

Most rules interfaces allow creation of somewhat complex rules that include programming language like functionality, such as, for example, conditional logic (e.g., if-then-else statements) and string matching. Thus, it is possible for a user to create a rule including a number of conditional statements. When an electronic mail message is received, the electronic mail application linearly executes each conditional statement (i.e., one after another) to attempt to identify a rule criterion that is satisfied. If a rule criterion is satisfied (e.g., sender =<e-mail address of business partner>, a string comparison), the electronic mail application automatically performs a corresponding rule action (e.g., forwarding the electron message to an administrative assistant).

Unfortunately, electronic mail applications often execute electronic mail rules inefficiently. For example, since conditional statements are often executed linearly, some conditional statements are always executed before other conditional statements. Thus, an electronic mail application can execute a number of conditional statements that do not satisfy a rule criterion in an attempt to identify a conditional statement that does satisfy a rule criterion. Accordingly, a conditional statement that satisfies a rule criterion may be executed after a number of conditional statements that do not satisfy a rule criterion. Since execution of each conditional statement consumes system resources, it may be that system resources are consumed by executing a number of conditional statements that do not satisfy a rule criterion.

String matching is matching a known string (e.g., included in a rule criteria) against one or more other strings (e.g., contained in received electronic mail message) to determine if the strings are the same. String matching typically includes matching a known string to another string on a character by character basis. As long as the next character of both the known string and another string match, the other string is retained for further matching. For example, a known string “computer” can be matched to another string “computer” by first determines that the first letters match, then determining that the second letters match, etc.

However, when a known string and another string have a number of the matching characters but are not a completed match, system resources can be inefficiently comsumed. For example, a known string “computer” does not match another string “computing. However, an executed mail rule will typically perform character by character matching on the first six characters. Thus, resources are consumed to match the first six characters even though the strings are not a complete match. Other types of electronic mail rule functionality can also lead to inefficient use of resources.

Further, while rules interfaces typically allow some flexibility in rule creation, it is difficult to extend rule action and/or rule criteria functionality beyond the functionality initial coded into a corresponding electronic mail application. That is, electronic mail applications are designed to support a limited set of rule criteria and rule actions. Further, support for rule criteria and rule actions are often hard-coded into electronic mail applications, making it difficult, if not impossible, to change supported rule criteria and rule actions.

Additionally, electronic message rules are often stored in a format that is proprietary to a particular electronic mail application. Thus to manipulate existing rules for an electronic mail application, a user is typically required to use the rules interface corresponding to the electronic mail application (since other applications are not aware of the propriety data format). Accordingly, there is often no efficient way to manipulate electronic mails rules (even for supported rule criteria and rule actions) using other applications. Accordingly, systems, methods, and computer program products that facilitate extending and optimizing electronic messaging rules would be advantageous.

### BRIEF SUMMARY OF THE INVENTION

The foregoing problems with the prior state of the art are overcome by the principles of the present invention, which are directed towards methods, systems, and computer program products for extending and optimizing electronic messaging rules. In some embodiments, a computer system receives rule input at a user-interface. The rule input includes a message rule criterion and corresponding messaging rule action. The computer system generates a messaging rule based on the rule input such that when a message satisfies the message rule criterion, the message rule action is performed. The computer system generates intermediate language rule instructions that represent the messaging rule and that can be executed at a corresponding rule execution module. The computer system outputs the intermediate language rule instructions such that the intermediate language rule instructions are accessible for subsequent modification.

In other embodiments, a computer system accesses intermediate language rule instructions representing one or more messaging rules. The computer system accesses rule identification criteria identifying specified intermediate language rule instructions that can be optimized to cause message rule execution to be more efficient. The computer system utilizes the accessed rule identification criteria to identify a portion of the accessed intermediate language rule instructions that can be optimized to cause a corresponding messaging rule to execute more efficiently. The computer system generates optimized intermediate language rule instructions based on rule optimization data. The computer system outputs the optimized intermediate language rule instructions.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a computer architecture that facilitates generating and modifying extensible messaging rules.

FIG. 2 illustrates an example of a computer architecture that facilitates optimizing messaging rules.

FIG. 3 illustrates an example flow chart of a method for generating extensible messaging rules.

FIG. 4 illustrates an example flow chart of a method for optimizing messaging rules.

FIG. 5 illustrates a suitable operating environment for the principles of the present invention.

### DETAILED DESCRIPTION OF THE PREFERRED EMBODIMENTS

The principles of the present invention provide for extending and optimizing electronic messaging rules. In some embodiments, a computer system receives rule input at a user-interface. The rule input includes a message rule criterion and corresponding messaging rule action. The computer system generates a messaging rule based on the rule input such that when a message satisfies the message rule criterion, the message rule action is performed. The computer system generates intermediate language rule instructions that represent the messaging rule and that can be executed at a corresponding rule execution module. The computer system outputs the intermediate language rule instructions such that the intermediate language rule instructions are accessible for subsequent modification.

Accordingly, the computer system can subsequently decompile the intermediate language rule instructions into corresponding source code rule instructions. The computer system modifies the source code rule instructions (e.g., based on input from a technically proficient user) to generate modified source code rule instructions that extend the functionality of the messaging rule. The computer system compiles the modified source code rule instructions into modified intermediate language rule instructions that can be executed at the rule execution module.

Alternately, a technical proficient user directly generates source code rule instructions. The source code rule instructions are compiled into intermediate language rule instruction that can be executed at the corresponding rule execution module.

In other embodiments, a computer system accesses intermediate language rule instructions representing one or more messaging rules. The computer system accesses rule identification criteria identifying specified intermediate language rule instructions that can be optimized to cause message rule execution to be more efficient. The computer system utilizes the accessed rule identification criteria to identify a portion of the accessed intermediate language rule instructions that can be optimized to cause a corresponding messaging rule to execute more efficiently. The computer system generates optimized intermediate language rule instructions based on rule optimization data. The computer system outputs the optimized intermediate language rule instructions.

Embodiments within the scope of the present invention include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer system, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions. The computer-executable instructions may be, for example, binaries, intermediate language instructions, assembly language, or even source code.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a network. Likewise, a computer system may include a single physical device (such as a mobile phone or Personal Digital Assistant “PDA”) where internal modules (such as a memory and processor) work together to perform operations on electronic data.

Those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Generally, an appropriately configured compiler (e.g., a Microsoft®.NET compiler) can receive source code (e.g., C#, C++, or Visual Basic source code) and compile the source code into language and platform independent portable executables containing metadata and intermediate language instructions. Metadata describes the types, members (e.g., methods, fields, properties, events), and attributes defined in the source code. Intermediate language instructions are operation codes that perform operations on portions of metadata (e.g., metadata tokens) when a portable executable is executed. A just-in-time (“JIT”) compiler, which translates language independent portable executables into machine specific executable code, can facilitate the coordination of operation codes and portions of metadata at the time of execution. Accordingly, portable executable developed in one computing environment (e.g., in C++ at a computer system running a Unix operating system) can be executed in any other environment (e.g., a computer system running a Microsoft® Windows operating system) with access to an appropriate JIT compiler.

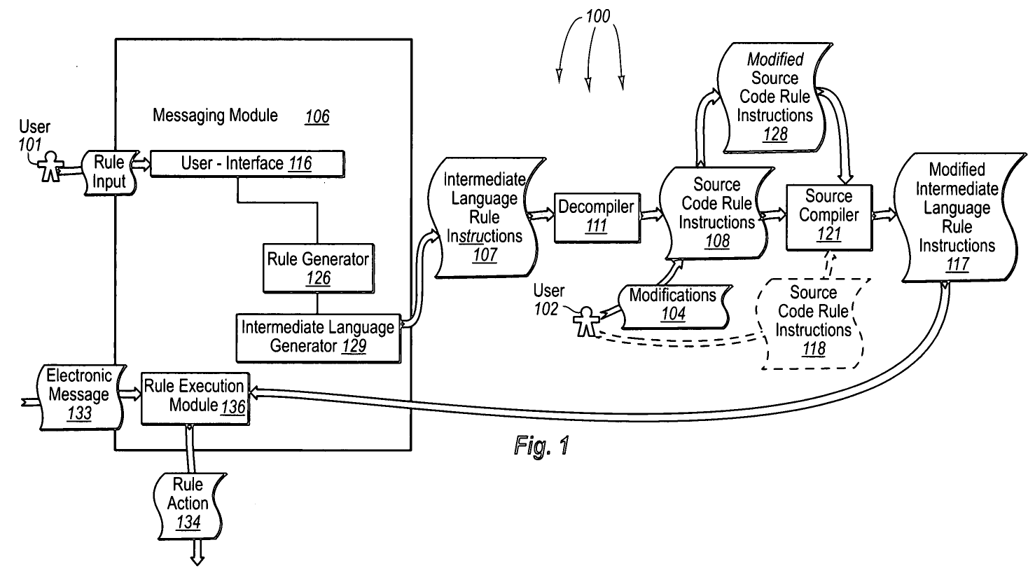

FIG. 1 illustrates an example of a computer architecture 100 that facilitates generating and modifying extensible messaging rules. Computer architecture 100 can be included in network connected computer system (not shown). The computer system can be connected to a network, such as, for example, a Local Area Network (“LAN”), Wide Area Network (“WAN”), or even the Internet. The computer system, as well as other network connected computer systems (not shown), can exchange message related data (e.g., included in Internet Protocol (“IP”) datagrams and in accordance with other higher layer protocols that utilize IP datagrams, such as, Transmission Control Protocol (“TCP”), Hypertext Transfer Protocol (“HTTP”), Simple Mail Transfer Protocol (“SMTP”), Post Office Protocol (“POP”), Internet Message Access Protocol (“IMAP”), etc.) over the network.

As depicted in computer architecture 100, messaging module 106 (e.g., a portion on an electronic mail application) includes user-interface 116, rule generator 126, intermediate language generator 129, and rule execution module 129. User-interface 116 can receive rule input from a user of messaging module 106. Rule input can include an indication of rule criteria and/or rule actions that are to be included as part of an electronic messaging rule. User-interface 116 can pass received rule input to rule generator 126, which in turn generates a messaging rule based in the received rule input. Intermediate language generator 129 can generate intermediate language rule instructions that represent the generated messaging rule.

Intermediate language rule instructions can be part of a portable executable assembly that is executable in accordance with a common language runtime (“CLR”). Thus, any appropriate execution module that conforms to the CLR (e.g., an appropriate Just-In-Time (“JIT”) compiler) can execute intermediate language rule instructions to implement the represented messaging rule.

It may be that any number of programming languages (e.g., C#, C++, and Visual Basic) can be compiled into intermediate language instructions of the same intermediate language. Further, the constructs of the intermediate language can be known such that intermediate language instructions can be decompiled into any of the number of programming languages. Accordingly, decompiler 111 can decompile intermediate language rule instructions into corresponding source code rule instructions. Source code instructions can be of any programming language that can be compiled back into intermediate language instructions.

A technically proficient user (e.g., user 102) can enter modifications to extend the functionality of a messaging rule represented by source code rule instructions. For example, modifications to source code rule instructions can extend a messaging rule to include rule criteria and/or rule actions that intermediate language generator 129 is not configured to generate (but that can be executed at rule execution module 136). Alternately, a technically proficient user can manually generate source code rule instructions. Thus, computer architecture 100 enables a technically proficient user to extend existing messaging rules as well as manually generate new messaging rules (which are also extensible).

Source compiler 121 can compile modified source code rule instructions into modified intermediate language rule instructions. Likewise, source compiler 121 can compile manfully generated source code rule instructions into appropriate intermediate language rule instructions.

When an electronic message is received, rule execution module 136 can execute modified intermediate language rule instructions to implement a represented (and potentially extended) messaging rule. For example, it may be that rule execution module includes an appropriate JIT compiler. Based on the (potentially extended) functionality of the represented messaging rule, rule execution module 136 can perform a rule action (e.g., as indicated in rule input). For example, when an electronic message satisfies rule criteria (e.g., as indicated in rule input) of the represented rule, rule execution module 136 can indicate received mail on a remote mobile device (e.g., a mobile phone or PDA). Electronic messages can be transferred, for example, in accordance with SMTP, POP, and IMAP.

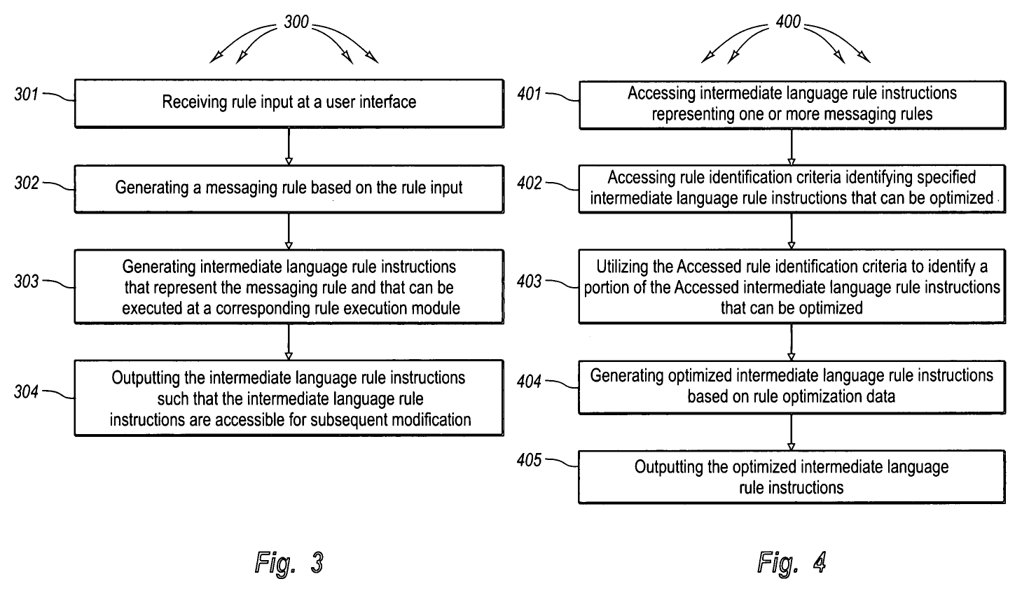

FIG. 3 illustrates an example flow chart 300 of a method for generating extensible messaging rules. The method 300 will be described with respect to the modules and data depicted in computer architecture 100.

Method 300 includes an act of receiving rule input at a user-interface (act 301). The rule input can include a messaging rule criterion and a corresponding messaging rule action. For example, user-interface 116 can receive rule input 103 that includes a messaging rule criterion and a corresponding messaging rule action. User 101 can enter rule input 103 at an input device, such as, for example, a keyboard or mouse.

Method 300 includes an act of generating a messaging rule based on the rule input (act 302). A messaging rule can indicate that a message rule action is to be performed when a message satisfies the corresponding message rule criterion. For example, rule generator 126 can generate a message rule based on rule input 103. The messaging rule can indicate that a rule action is to be executed (e.g., moving an electronic message to a folder, forwarding or deleting an electronic message, etc.) when a message satisfies a corresponding rule criterion (e.g., is from a specified user, contains specified text, etc.).

Method 300 includes an act generating intermediate language rule instructions that represent the messaging rule and that can be executed at a corresponding rule execution module (act 303). For example, intermediate language generator 129 can generate intermediate language rule instructions 107. Intermediate language generator 129 can include functionality to convert messaging rules defined in accordance with a rule format used by rule generator 126 (potentially source code format or some proprietary format) into intermediate language instructions 107. Intermediate language rule instructions 107 can be of a format that is executable at rule execution module 136.

Method 300 includes an act outputting the intermediate language rule instructions such that the intermediate language rules instructions are accessible for subsequent modification (act 304). For example, messaging module 106 can output intermediate language rule instructions 107 to a magnetic hard disk for storage. Intermediate language rule instructions 107 can be stored in a specified location external to message module 106 so that other modules, in addition to message module 106, can access intermediate language rule instructions 107.

Thus, decompiler 111 can subsequently decompile intermediate language instructions 107 into corresponding source code rule instructions 108. User 102 can modify source code rule instructions 108 in accordance with modifications 104 to generate modified source code rule instructions 128 that extend the functionality of a represented messaging rule. Alternately, user 102 can manual generated source code rule instructions 118. As previously described, source code rule instructions can be instructions of a general purpose programming language (e.g., C#, C++, Visual Basic, etc.). Thus, modified source code rule instructions 128 can extend a represented messaging rule to provide any functionality available to the general purpose programming language. Source compiler 121 (e.g., a C#, C++, Visual Basic, or other appropriate compiler) can compile modified source code rule instructions 128 into modified intermediate language rule instructions 117 that can be executed at rule execution module 136. Similarly, source compiler 121 can compile source code instructions 118 into appropriate intermediate language rule instructions.

When electronic message 133 (e.g., an electronic mail message) is received, rule execution module can execute modified intermediate language rule instructions 117. Rule execution module can determine if electronic message 133 satisfies a rule criterion of the represented messaging rule. When a rule criterion is satisfied, rule execution module 136 can cause rule action 134 to occur.

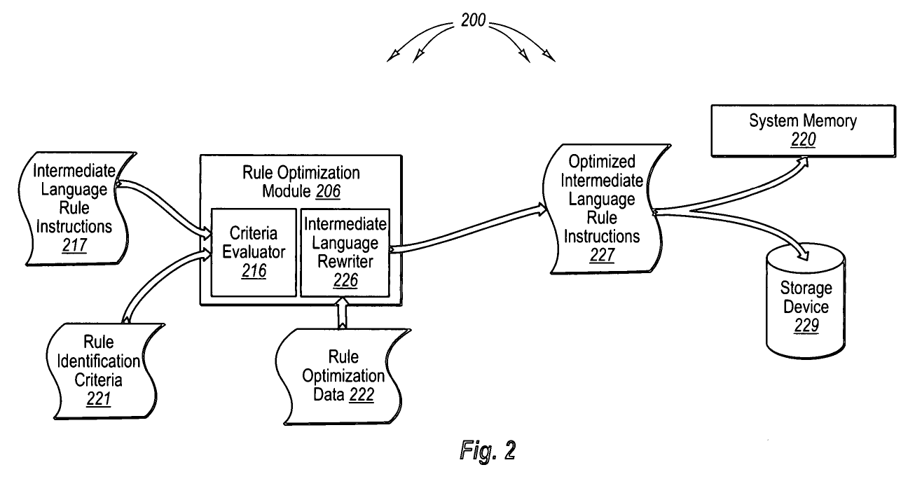

FIG. 2 illustrates an example of a computer architecture 200 that facilitates optimizing messaging rules. Similar to computer architecture 100, computer architecture 200 can be included in a networked computer system that exchanges message related data with other network computer systems.

As depicted in computer architecture 200, rule optimization module 206 includes criteria evaluator 216 and intermediate language rewriter 226. Generally, based on rule identification criteria 221, criteria evaluator 216 identifies intermediate language instructions that can be optimized for more efficient execution. Intermediate language rewriter 266 can rewrite identified intermediate language instructions according to rule optimization data 222. Rule optimization data 222 can include data indicating how various intermediate language instructions are to be optimized for more efficient execution.

For example, rule optimization data 222 can include a data structure used to represent an otherwise linearly executed series of conditional statements (e.g., a series of if-then statements) as a balanced binary tree. Thus, execution time of a series of conditional statements can be reduced from N (e.g., 8) to a value between Nlog₂ (e.g., 3) and Nlog₂+1 (e.g., 4). Rule optimization data 222 can also include a data structure used to represent string values as corresponding hash values. Thus, execution time for a string comparison can be reduced from N individual character comparisons to a single hash value comparison. Rule optimization data 222 can also include optimizations for other intermediate language instructions. It would be apparent to one skilled in the art, after having reviewed this description, that other types of optimizations, in addition to the used of binary trees and hash values, can be used to optimize the execution of intermediate language instructions.

Rule optimization module 206 can output optimized intermediate language instructions 227 to system memory or other appropriate storage device.

FIG. 4 illustrates an example flow chart of a method 400 for optimizing messaging rules. The method 400 will be described with respect to the components and data in computer architecture 200.

Method 400 includes an act of accessing intermediate language rule instructions representing one or more messaging rules (act 401). For example, rule optimization module 206 can access intermediate language rule instructions 217. Intermediate language rule instructions 217 can be automatically generated intermediate language rule instructions (e.g., intermediate language rule instructions 107), modified intermediate language rule instructions (e.g., modified intermediate language rule instructions 117), or intermediate language rule instructions compiled from manually generated source code rule instructions (e.g., source code rule instructions 118).

Method 400 includes an act of accessing rule identification criteria identifying specified intermediate language rule instructions that can be optimized (act 402). For example, rule optimization module 206 can access rule identification criteria 221. Rule identification criteria 221 identifies intermediate language instructions, such as, for example, conditional statements and string comparison statements, that can be optimized.

Method 400 includes an act of utilizing the accessed rule identification criteria to identify a portion of the accessed intermediate language rule instructions that can be optimized (act 403). For example, criteria evaluator 216 can identify a portion of intermediate language rule instructions 217 (e.g., a series of related conditional statements) that can be optimized.

Method 400 includes an act of generating optimized intermediate language rule instructions based on rule optimization data (act 404). For example, intermediate language rewriter can generate optimized intermediate language rule instructions 227 based on rule optimization data 222. Rewriting intermediate language instructions can include replacing a series of related conditional statements with a balanced binary tree or replacing a character by character string comparison with comparison of single hash value.

Method 400 includes an act of outputting the optimized intermediate language rule instructions (act 405). For example, rule optimization module 206 can output optimized intermediate language rule instructions 227 to system memory 220 and/or storage device 229. Optimized intermediate language rule instructions 227 can be stored in system memory 220 when a messaging module (e.g., messaging module 106) is active. Optimized intermediate language rule instructions 227 can be stored at storage device 229 when a messaging module (e.g., messaging module 106) is inactive. Optimized intermediate language rule instructions 227 can be loaded form storage device 220 to system memory 220 when the messaging module becomes active.

Rule execution module 136 can execute optimized intermediate language rule instructions to determine if a received message (e.g., electronic message 133) satisfies rule criterion of can represented rules. When a rule criterion is satisfied, rule execution module can cause a rule action to occur. Optimized intermediate language rule instructions can be executed more efficiently than non-optimized intermediate language rule instructions. Thus, execution of optimized intermediate language rule instructions conserves resources of computer architecture 100.

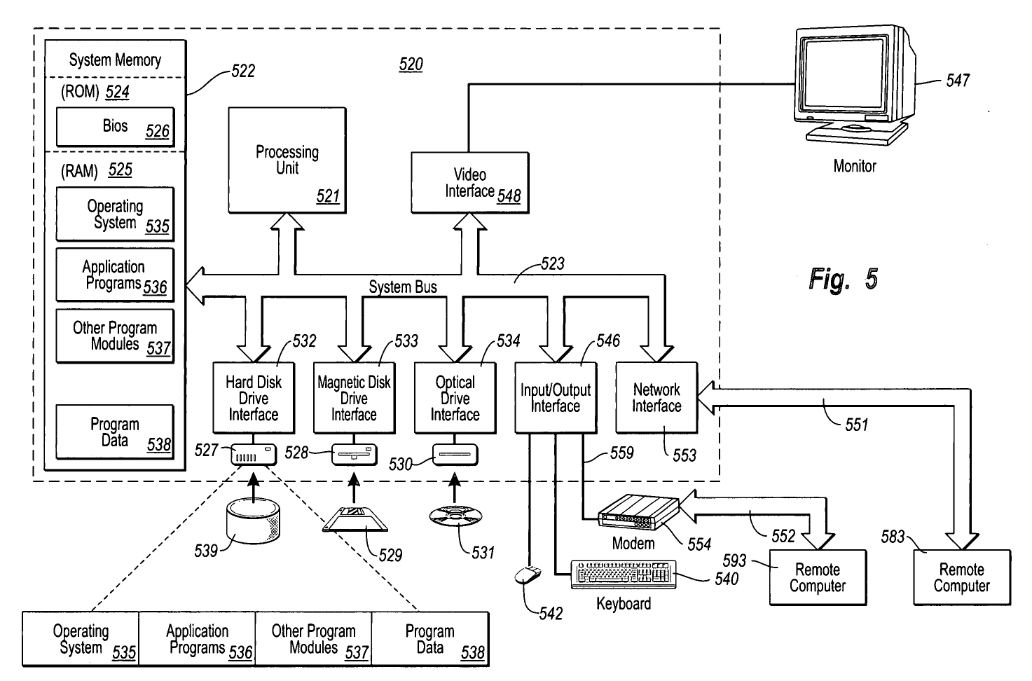

FIG. 5 illustrates a suitable operating environment for the principles of the present invention. FIG. 5 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference to FIG. 5, an example system for implementing the invention includes a general-purpose computing device in the form of computer system 520, including a processing unit 521, a system memory 522, and a system bus 523 that couples various system components including the system memory 522 to the processing unit 521. Processing unit 521 can execute computer-executable instructions designed to implement features of computer system 520, including features of the present invention. The system bus 523 may be any of several types of bus structures including a memory bus or memory controller, a peripheral bus, and a local bus using any of a variety of bus architectures. The system memory includes read only memory (“ROM”) 524 and random access memory (“RAM”) 525. A basic input/output system (“BIOS”) 526, containing the basic routines that help transfer information between elements within computer system 520, such as during start-up, may be stored in ROM 524.

The computer system 520 may also include magnetic hard disk drive 527 for reading from and writing to magnetic hard disk 539, magnetic disk drive 528 for reading from or writing to removable magnetic disk 529, and optical disk drive 530 for reading from or writing to removable optical disk 531, such as, or example, a CD-ROM or other optical media. The magnetic hard disk drive 527, magnetic disk drive 528, and optical disk drive 530 are connected to the system bus 523 by hard disk drive interface 532, magnetic disk drive-interface 533, and optical drive interface 534, respectively. The drives and their associated computer-readable media provide nonvolatile storage of computer-executable instructions, data structures, program modules, and other data for the computer system 520. Although the example environment described herein employs magnetic hard disk 539, removable magnetic disk 529 and removable optical disk 531, other types of computer readable media for storing data can be used, including magnetic cassettes, flash memory cards, digital versatile disks, Bernoulli cartridges, RAMs, ROMs, and the like.

Program code means comprising one or more program modules may be stored on hard disk 539, magnetic disk 529, optical disk 531, ROM 524 or RAM 525, including an operating system 535, one or more application programs 536, other program modules 537, and program data 538. A user may enter commands and information into computer system 520 through keyboard 540, pointing device 542, or other input devices (not shown), such as, for example, a microphone, joy stick, game pad, scanner, or the like. These and other input devices can be connected to the processing unit 521 through input/output interface 546 coupled to system bus 523. Input/output interface 546 logically represents any of a wide variety of different interfaces, such as, for example, a serial port interface, a PS/2 interface, a parallel port interface, a Universal Serial Bus (“USB”) interface, or an Institute of Electrical and Electronics Engineers (“IEEE”) 1394 interface (i.e., a FireWire interface), or may even logically represent a combination of different interfaces.

A monitor 547 or other display device is also connected to system bus 523 via video interface 548. Other peripheral output devices (not shown), such as, for example, speakers and printers, can also be connected to computer system 520.

Computer system 520 is connectable to networks, such as, for example, an office-wide or enterprise-wide computer network, a home network, an intranet, and/or the Internet. Computer system 520 can exchange data with external sources, such as, for example, remote computer systems, remote applications, and/or remote databases over such networks.

Computer system 520 includes network interface 553, through which computer system 520 receives data from external sources and/or transmits data to external sources. As depicted in FIG. 5, network interface 553 facilitates the exchange of data with remote computer system 583 via link 551. Network interface 553 can logically represent one or more software and/or hardware modules, such as, for example, a network interface card and corresponding Network Driver Interface Specification (“NDIS”) stack. Link 551 represents a portion of a network (e.g., an Ethernet segment), and remote computer system 583 represents a node of the network.

Likewise, computer system 520 includes input/output interface 546, through which computer system 520 receives data from external sources and/or transmits data to external sources. Input/output interface 546 is coupled to modem 554 (e.g., a standard modem, a cable modem, or digital subscriber line (“DSL”) modem) via link 559, through which computer system 520 receives data from and/or transmits data to external sources. As depicted in FIG. 5, input/output interface 546 and modem 554 facilitate the exchange of data with remote computer system 593 via link 552. Link 552 represents a portion of a network and remote computer system 493 represents a node of the network.

While FIG. 5 represents a suitable operating environment for the present invention, the principles of the present invention may be employed in any system that is capable of, with suitable modification if necessary, implementing the principles of the present invention. The environment illustrated in FIG. 5 is illustrative only and by no means represents even a small portion of the wide variety of environments in which the principles of the present invention may be implemented.

In accordance with the present invention, modules including rule generators, intermediate language generators, compilers, decompilers, rule execution modules, rule execution modules, criteria evaluators, and intermediate language rewriters as well as associated data, including rule input, intermediate language instructions, source code instructions, rule criteria, rule actions, electronic messages, rule identification criteria, rule optimization data, can be stored and accessed from any of the computer-readable media associated with computer system 520. For example, portions of such modules and portions of associated program data may be included in operating system 535, application programs 536, program modules 537 and/or program data 538, for storage in system memory 522.

When a mass storage device, such as, for example, magnetic hard disk 539, is coupled to computer system 520, such modules and associated program data may also be stored in the mass storage device. In a networked environment, program modules depicted relative to computer system 520, or portions thereof, can be stored in remote memory storage devices, such as, system memory and/or mass storage devices associated with remote computer system 583 and/or remote computer system 593. Execution of such modules may be performed in a distributed environment as previously described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired secured by United States Letters Patent is:

1. At a computer system, a method for generating extensible messaging rules, the method comprising:
an act of receiving rule input at a user-interface, the rule input including a messaging rule criterion and a corresponding messaging rule action;
an act of generating a messaging rule based on the rule input such that when a message satisfies the message rule criterion, the message rule action is performed; and
an act of generating intermediate language rule instructions that represent the messaging rule and that can be executed at a corresponding rule execution module; and
an act of outputting the intermediate language rule instructions such that the intermediate language rule instructions are accessible for subsequent modification.

2. The method as recited in claim 1, wherein the act of receiving rule input at a user-interface comprises an act of receiving user input at the user interface.

3. The method as recited in claim 1, wherein the act of generating a messaging rule based on the rule input comprises an act of generating source code instructions representing the messaging rule.

4. The method as recited in claim 1, wherein the act of generating a messaging rule based on the rule input comprises an act of a rule generator generating source code instructions representing the messaging rule.

5. The method as recited in claim 4, wherein the act of generating source code instructions representing the messaging rule comprises an act of generating source code instructions of a programming language selected from among C++, C#, and Visual Basic.

6. The method as recited in claim 1, wherein the act of generating a messaging rule based on the rule input comprises an act of a rule generator generating a messaging rule in a message module proprietary format.

7. The method as recited in claim 1, wherein the act of generating intermediate language rule instructions comprises an act of compiling source code into intermediate language instructions.

8. The method as recited in claim 1, wherein the act of generating intermediate language rule instructions comprises an act of converting a messaging rule in a message module proprietary format into intermediate language instructions.

9. The method as recited in claim 1, wherein the act of outputting the intermediate language rule instructions comprises on act of storing the intermediate language instructions at a storage device external to a corresponding messaging module.

10. The method as recited in claim 1, further comprising:
an act of decompiling the intermediate language rule instructions into corresponding source code rule instructions;
an act of modifying the source code rule instructions to generate modified source code rule instructions, the modified source code rule instructions extending the functionality of the messaging rule; and
an act of compiling the modified source code rule instructions into modified intermediate language rule instructions that can be executed at the rule execution module.

11. The method as recited in claim 10, wherein the act of decompiling the intermediate language rule instructions into corresponding source code rule instructions comprises decompiling the intermediate language rule instructions into source code instructions of a programming language selected from among C++, C# and Visual Basic.

12. The method as recited in claim 10, wherein that act of modifying the source code rule instructions comprises an act of receiving user input that indicates how the source code rule instructions are to be modified.

13. The method as recited in claim 10, wherein the act of compiling the modified source code rule instructions into modified intermediate language rule instructions comprises compiling modified source code rule instructions into modified intermediate language rule instructions that can be executed at an appropriate Just-In-Time compiler.

14. The method as recited in claim 10, further comprising:
an act of receiving an electronic mail message;
an act of executing the modified intermediate language rule instructions to implement the represented rule; and
an act of performing a rule action based on the electronic mail message satisfying a rule criterion of the represented messaging rule.

15. At a computer system, a method for optimizing messaging rules, the method comprising:
an act of accessing intermediate language rule instructions representing one or more messaging rules;
an act of accessing rule identification criteria, the rule identification criteria identifying specified intermediate language rule instructions that can be optimized to cause message rule execution to be more efficient;
an act of utilizing the received rule identification criteria to identify a portion of the received intermediate language rule instructions that can be optimized to cause a corresponding messaging rule to execute more efficiently;
an act of generating optimized intermediate language rule instructions based on rule optimization data; and
an act of outputting the optimized intermediate language rule instructions.

16. The method as recited in claim 15, wherein the act of accessing intermediate language rule instructions comprises an act of accessing intermediate language rule instructions that were generated by an intermediate language generator.

17. The method as recited in claim 15, wherein the act of accessing intermediate language rule instructions comprises an act of accessing intermediate language rule instructions that were modified by user.

18. The method as recited in claim 15, wherein the act of accessing intermediate language rule instructions comprises an act of accessing intermediate language rule instructions that were created from corresponding source code rule instructions manually entered by a user.

19. The method as recited in claim 15, wherein the act of accessing rule identification criteria comprises an act of accessing rule identification criteria that indicates conditional statements can be optimized.

20. The method as recited in claim 15, wherein the act of accessing rule identification criteria comprises an act of accessing rule identification criteria that indicates string comparison statements can be optimized.

21. The method as recited in claim 15, wherein the act of utilizing the received rule identification criteria to identify a portion of the received intermediate language rule instructions that can be optimized comprises an act of identifying a plurality of related conditional statements that can be optimized.

22. The method as recited in claim 15, wherein the act of utilizing the received rule identification criteria to identify a portion of the received intermediate language rule instructions that can be optimized comprises an act of identifying a string comparison statement that can be optimized.

23. The method as recited in claim 15, wherein the act of an act of generating optimized intermediate language rule instructions comprises rewriting intermediate language rule instructions representing a plurality of related conditional statements as intermediate language rule instructions representing a balanced binary tree.

23. The method as recited in claim 15, wherein the act of generating optimized intermediate language rule instructions comprises an act of rewriting intermediate language rule instructions representing a character by character string comparison statement as intermediate language rule instructions representing hash comparison statement.

24. The method as recite in claim 15, wherein the act of outputting the optimized intermediate language rule instructions comprises storing the optimized intermediate language rule instructions in system memory.

25. The method as recite in claim 15, wherein the act of outputting the optimized intermediate language rule instructions comprises storing the optimized intermediate language rule instructions at a storage device.

26. The method as recited in claim 15, further comprising:
an act of executing the optimized intermediate language rule instructions to implement a messaging rule.

27. A computer program product for use at a computer system, the computer program product for implementing a method for generating extensible messaging rules, the computer program product comprising one or more computer-readable media having stored thereon computer-executable instructions that, when executed by a processor, cause the computer system to perform the following:
receive rule input at a user-interface, the rule input including a messaging rule criterion and a corresponding messaging rule action;
generate a messaging rule based on the rule input such that when a message satisfies the message rule criterion, the message rule action is performed; and
generate intermediate language rule instructions that represent the messaging rule and that can be executed at a corresponding rule execution module; and
output the intermediate language rule instructions such that the intermediate language rule instructions are accessible for subsequent modification.

28. The computer program product as recited in 27, further comprising computer-executable instructions that, when executed by a processor, cause the computer system to perform the following:
decompile the intermediate language rule instructions into corresponding source code rule instructions;
modify the source code rule instructions to generate modified source code rule instructions, the modified source code rule instructions extending the functionality of the messaging rule; and
compile the modified source code rule instructions into modified intermediate language rule instructions that can be executed at the rule execution module.

29. The computer program product as recited in 27, further comprising computer-executable instructions that, when executed by a processor, cause the computer system to perform the following:
receive an electronic mail message;
execute the intermediate language rule instructions to implement the represented rule; and
perform a rule action based on the electronic mail message satisfying a rule criterion of the represented messaging rule.

30. A computer program product for use at a computer system, the computer program product for implementing a method for optimizing messaging rules, the computer program product comprising one or more computer-readable media having stored thereon computer-executable instructions that, when executed by a processor, cause the computer system to perform the following:
access intermediate language rule instructions representing one or more messaging rules;
access rule identification criteria, the rule identification criteria identifying specified intermediate language rule instructions that can be optimized to cause message rule execution to be more efficient;
utilize the received rule identification criteria to identify a portion of the received intermediate language rule instructions that can be optimized to cause a corresponding messaging rule to execute more efficiently;
generate optimized intermediate language rule instructions based on rule optimization data; and
output the optimized intermediate language rule instructions.

31. The computer program product as recited in claim 30, wherein computer-executable instructions that, when executed by a processor, cause the computer system to generate optimized intermediate language rule instructions based on rule optimization data comprise computer-executable instructions that, when executed by a processor, cause the computer system to rewrite intermediate language rule instructions representing a plurality of related conditional statements as intermediate language rule instructions representing a balanced binary tree.

32. The computer program product as recited in claim 30, wherein computer-executable instructions that, when executed by a processor, cause the computer system to generate optimized intermediate language rule instructions based on rule optimization data comprise computer-executable instructions that, when executed by a processor, cause the computer system to rewriting intermediate language rule instructions representing a character by character string comparison statement as intermediate language rule instructions representing hash comparison statement.
